(19) United States
(12) Patent Application Publication
(10) Pub. No.: US 2007/0260837 A1
(43) Pub. Date: Nov. 8, 2007

(54) METHOD OF DYNAMIC MEMORY MANAGEMENT FOR A PORTABLE DATA STORAGE DEVICE

(75) Inventor: Chang-Wei Hsu, Taipei Hsien (TW)

Correspondence Address: DARBY & DARBY P.C., P.O. BOX 770, Church Street Station, New York, NY, 10008-0770, US

(73) Assignee: Apacer Technology Inc., Taipei Hsien (TW)

(21) Appl. No.: 11/566,770

(22) Filed: Dec. 5, 2006

(30) Foreign Application Priority Data
May 8, 2006 (TW) 095116223

(51) Int. Cl. G06F 12/14; G06F 12/00

(52) U.S. Cl. 711/163; 711/115

(57) ABSTRACT

A method of dynamic memory management for a portable data storage device having a semiconductor memory includes: a) providing a state-changeable label used for setting an access state of a data storing zone of the semiconductor memory, the label being in one of a first state indicating access to data in the data storing zone is allowed, and a second state indicating access to the data in the data storing zone is restricted; b) allowing access to the data storing zone when the label is in the first state; and c) restricting access to the data storing zone when the label is in the second state.

### CROSS-REFERENCE TO RELATED APPLICATION

This application claims priority of Taiwanese Application No. 095116223, filed on May 8, 2006.

### BACKGROUND OF THE INVENTION

1. Field of the Invention

The present invention relates to a portable data storage device, more particularly to a method of dynamic memory management for a portable data storage device.

2. Description of the Related Art

A semiconductor memory, such as that installed in a USB (Universal Serial Bus) pen drive, an MP3 (Moving Picture Experts Group audio Layer-3) player, or other similar portable data storage device, is typically configured to have a data storing zone for stored data, and a reserved zone used when conducting write and erase operations and also used for bad blocks, storage of passwords, etc. For example, in the case of a 128 MB flash memory, where a block unit is 128 KB, there would be 1024 blocks, 992 of which may be allocated to the data storing zone and 32 of which may be allocated to the reserved zone. The size allocations for the data storing zone and the reserved zones are fixed beforehand and cannot be modified by the user.

The physical blocks included in the data storing zone and the reserved zone are not fixed and are not necessarily contiguous. Any block having no data stored therein or containing erased data may be assigned to the reserved zone. However, once data is written into the reserved zone, the blocks in the reserved zone that store the written data would be reassigned to the data storing zone, and other blocks in the data storing zone must be concomitantly assigned to the reserved zone in order to maintain the fixed size allocations of the data storing zone and the reserved zone.

The reserved zone includes free blocks, bad blocks, and other blocks. The number of free blocks must be non-zero to enable data writing and erasing operations. However, when the number of bad blocks in the reserved zone increases, the number of the free blocks in the reserved zone decreases accordingly. As a result, when the number of free blocks in the reserved zone eventually reaches zero, data writing and erasing operations are no longer possible, and the semiconductor memory is rendered unusable. Since there is no way for the user to ascertain that the number of free blocks is approaching zero, the user may not have the opportunity to perform data backup of the contents in the semiconductor memory before it becomes unusable.

While it is possible to fix a larger size allocation for the reserved zone to accommodate a larger number of bad blocks and thereby prolong the service life of the semiconductor memory, the size of the data storing zone would be undesirably reduced.

Further, the conventional portable data storage device provides no mechanism by which the user can prevent unauthorized access to the data in the semiconductor memory.

### SUMMARY OF THE INVENTION

Therefore, the object of this invention is to provide a method of dynamic memory management for a semiconductor memory in a portable data storage device that enables changes to size allocations for a data storing zone and a reserved zone of the semiconductor memory as needed, and that allows for changes to access states of the semiconductor memory.

The method of dynamic memory management of this invention includes: a) providing a state-changeable label used for setting an access state of the data storing zone, the label being in one of a first state indicating access to data in the data storing zone is allowed, and a second state indicating access to the data in the data storing zone is restricted; b) allowing access to the data storing zone when the label is in the first state; and c) restricting access to the data storing zone when the label is in the second state.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram illustrating an exemplary layout of a flash memory;

FIG. 2 is a flow chart of a method of dynamic memory management method for a portable data storage device according to a first preferred embodiment of the present invention;

FIG. 3 shows a mode-label look-up table according to the first preferred embodiment;

FIG. 4 is a flow chart of a method of dynamic memory management method for a portable data storage device according to a second preferred embodiment of the present invention;

FIG. 5 shows a mode-label look-up table according to the second preferred embodiment;

FIG. 6 is a flow chart according to the second preferred embodiment, illustrating steps involved in changing an access state of a data storing zone of the flash memory when the portable data storage device is initially in an abnormal mode;

FIG. 7 is a flow chart according to the second preferred embodiment, illustrating steps involved in changing the access state of the data storing zone of the flash memory when the portable data storage device is initially in a backup mode;

FIG. 8 is a flow chart according to the second preferred embodiment, illustrating steps involved in changing the access state of the data storing zone of the flash memory when the portable data storage device is initially in a normal mode;

FIG. 9 shows an allocation look-up table according to the second preferred embodiment, illustrating different possible allocations for the flash memory in the portable data storage device; and

FIG. 10 is a flow chart according to the second preferred embodiment, illustrating steps involved in dynamically increasing a capacity of a reserved zone of the flash memory in the portable data storage device.

### DETAILED DESCRIPTION OF THE PREFERRED EMBODIMENTS

Before the present invention is described in greater detail, it should be noted that like elements are denoted by the same reference numerals throughout the disclosure.

In the preferred embodiments of the present invention, the portable data storage device is assumed to include a first memory unit, a second memory unit, and a control chip. The first memory unit is a semiconductor memory such as a flash memory, the second memory unit includes a random access memory (RAM) and a read-only memory (ROM) and the control chip is installed with firmware that is used for determining a layout of the first memory unit and for configuring an electronic apparatus connected to the portable data storage device to perform various steps with respect to the first memory unit. The portable data storage device may be a USB pen drive or an MP3 player.

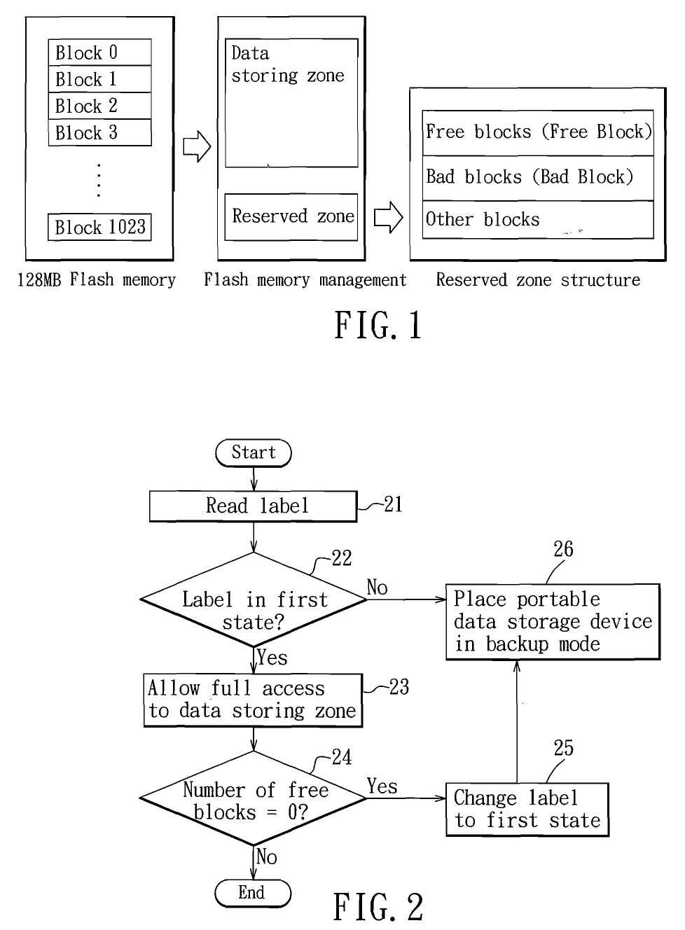

Using a 128 MB flash memory shown in FIG. 1 as an example, the firmware is used to determine the layout thereof such that the flash memory is divided into block units of 128 KB for a total of 1024 blocks. Further, the blocks are grouped into two separate zones of a data storing zone for storing data and a reserved zone. Initially, 992 data blocks may be allocated to the data storing zone and 32 blocks to the reserved zone.

The reserved zone includes free blocks (at most 31 blocks in this example), bad blocks (initially zero), and other blocks (one or more). The free blocks are used for memory access operations, i.e., data writing and erasing, as well as for replacing bad blocks in the data storing zone. For example, during a data write operation, data is written into one or more free blocks in the reserved zone, after which the free blocks in the reserved zone that store the written data are reassigned to the data storing zone and other blocks in the data storing zone are concomitantly assigned as free blocks in the reserved zone. Hence, the number of free blocks must be non-zero to enable data writing and erasing operations.

However, when the number of the bad blocks in the reserved zone increases, the number of the free blocks in the reserved zone decreases accordingly. If the number of free blocks in the reserved zone reaches zero, data writing and erasing operations are not possible and the portable data storage device is therefore rendered unusable. In the present invention, one of the first steps involved in remedying this situation is to determine the number of the free blocks in the reserved zone so that, if needed, a re-allocation of the blocks in the data storing zone and the reserved zone may be performed.

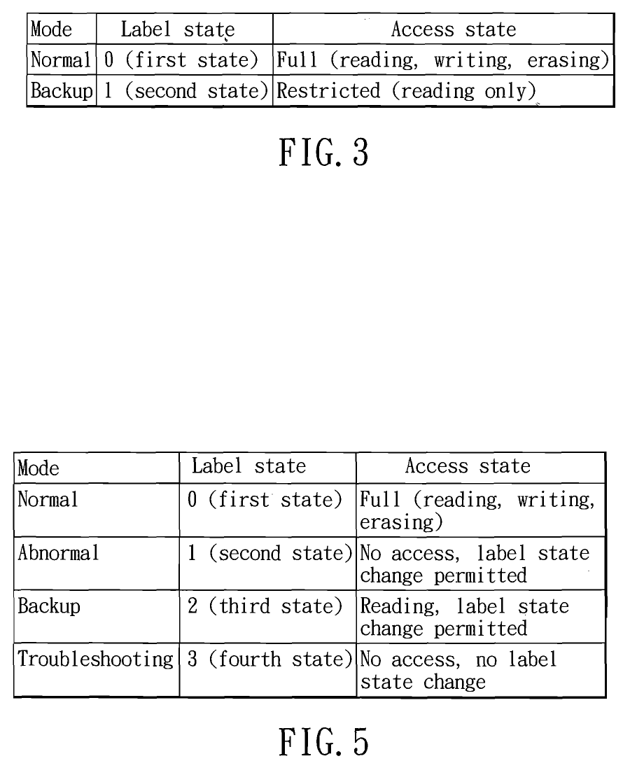

Referring to FIG. 3, the first preferred embodiment provides a state-changeable label used for setting an access state of the data storing zone, and a mode-label look-up table that lists different states of the label and corresponding access states of the data storing zone. When the number of the free blocks in the reserved zone is greater than 0, the label is set to a first state (0) and the portable data storage device is placed in a normal mode. In the normal mode, full access (i.e., reading, writing, and erasing operations) to data in the data storing zone is allowed. On the other hand, when the number of free blocks in the reserved zone is equal to 0, the label is set to a second state (1) and the portable data storage device is placed in a backup mode. In the backup mode, access to data in the data storing zone is restricted to only a reading operation, and writing and erasing operations are not allowed.

The present state of the label is stored in the other blocks of the reserved zone. Further, the mode-label look-up table, in which all the possible states of the label and their corresponding access states are tabulated as described above, is also stored in the other blocks of the reserved zone.

Every time the portable data storage device is connected to an electronic apparatus, such as a personal computer (PC), the firmware in the portable data storage device configures the electronic apparatus to perform the process of FIG. 2 with reference to the mode-label look-up table of FIG. 3.

First, in step 21, the label stored in the reserved zone is read and temporarily stored in the RAM of the second memory unit. Next, in step 22, it is determined if the label is in the first state (0), which corresponds to the normal mode of the portable data storage device. If so, in step 23, full access to the data storing zone by the electronic apparatus is allowed, as dictated by the mode-label look-up table of FIG. 3.

A block in the data storing zone may become defective during accessing of the data storing zone, in which case a free block in the reserved zone is used to replace the bad block and the number of the free blocks in the reserved zone is therefore reduced. Hence, following access to the data storing zone in step 23, it is determined if the number of the free blocks in the reserved zone equals zero in step 24. If not, the process is ended.

If, on the other hand, the number of the free blocks equals zero in step 24, this indicates that the reserved zone has no free blocks remaining to enable additional memory access operations (i.e., write and erase operations), but that reading of data in the data storing zone is still possible. Therefore, if the number of free blocks equals zero in step 24, the label is changed from the first state (0) to the second state (1) in step 25. Subsequently, in step 26, the portable data storage device is placed in the backup mode in which only reading of data from the data storing zone is permitted, while writing and erasing are not. Likewise, in step 22, if it is determined that the label is not in the first state (0), since the only other possibility is that of the label being in the second state (1), the portable data storage device is placed in the backup mode in step 26.

After the process of FIG. 2 is ended, the label state temporarily stored in the RAM of the second storage unit is written into the reserved zone of the first memory unit.

In the above-described process utilizing the label and the mode-label look-up table, if no additional free blocks are available in the reserved zone, which indicates that writing and erasing operations with respect to the data storing zone are no longer possible, the label is changed to the second state (1) and the portable data storage device is placed in the backup mode. These operations are performed automatically through launching of the firmware in the portable data storage device. In the backup mode, a user may perform only reading of data in the portable data storage device. However, this allows the user to initiate backup of the data in the portable data storage device. As a result, a situation is prevented by which the free blocks in the memory of the portable data storage device are used up all at once such that no access (even reading) is permitted and backup is no longer possible.

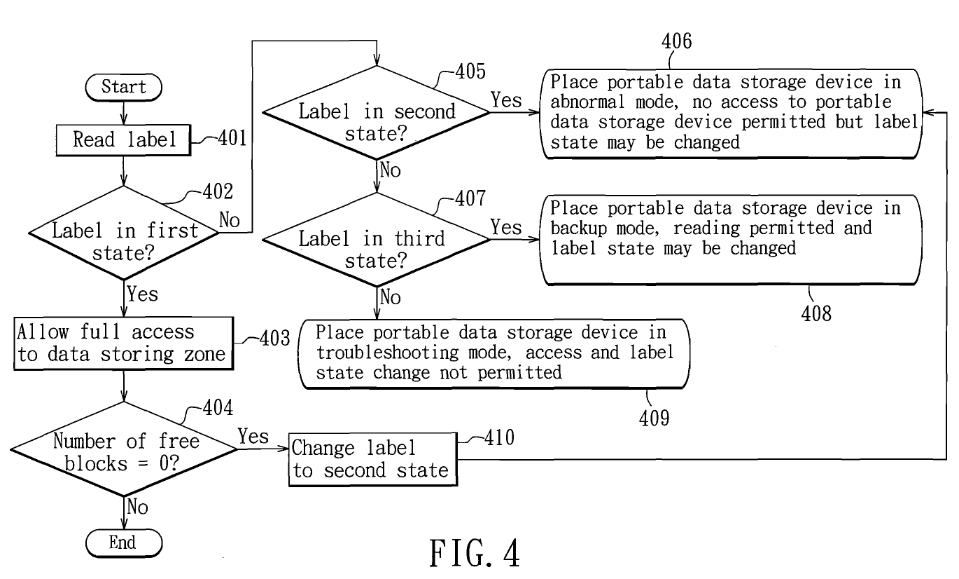

FIG. 4 illustrates steps involved in a method of dynamic memory management method for a portable data storage device according to a second preferred embodiment of the present invention. In this embodiment, both the firmware in the portable data storage device and software installed in an electronic apparatus (e.g., a PC) are used to perform the method.

A mode-label look-up table as shown in FIG. 5 is used in the second preferred embodiment. The mode-label look-up table of FIG. 5 is stored in the reserved zone, as in the case of the mode-label look-up table of FIG. 3. In the mode-label look-up table of FIG. 5, when the label is in a first state (0), the portable data storage device is placed in a normal mode, in which full access to the data in the data storing zone is permitted. When the label is in a second state (1), the portable data storage device is placed in an abnormal mode, in which no access to the data in the data storing zone is permitted but a label-state-change operation is possible (to be described below). When the label is in a third state (2), the portable data storage device is placed in a backup mode, in which reading of the data in the data storing zone is permitted (i.e., backup is possible), as is the label-state-change operation. When the label is in a fourth state (3), the portable data storage device is placed in a troubleshooting mode, in which both access to the portable data storage device and the label-state-change operation are not permitted.

Further, in the second preferred embodiment, the firmware configures the electronic apparatus to enable a change in the state of the label from the second state (1) to the first state (0), while the software configures the electronic apparatus to enable all other label-state-change operations.

When the portable data storage device is connected to the electronic apparatus, the process as shown in FIG. 4 is performed.

First, in step 401, the firmware configures the electronic apparatus to read the label stored in the reserved zone and temporarily store the label in the RAM of the second memory unit. Steps 401 to 404 of the dynamic memory management method of the second preferred embodiment are identical to steps 21 to 24, respectively, of the first preferred embodiment shown in FIG. 2.

However, in step 402, if it is determined that the label is not in the first state (0), step 405 is performed, in which it is determined if the label is in the second state (1). If, in step 405, the label is in the second state (1), the portable data storage device is placed in the abnormal mode in step 406, in which no access to the portable data storage device is permitted but the software installed in the electronic apparatus may be used to change the label state.

If, on the other hand, the label is not in the second state (1) in step 405, it is determined if the label is in the third state (2) in step 407. If so, in step 408, the portable data storage device is placed in the backup mode, in which reading is permitted and the software installed in the electronic apparatus may be used to change the label state.

If the label is not in the third state (2) in step 407, the portable data storage device is placed in the troubleshooting mode in step 409, in which no access to the data in the data storing zone is permitted and the software installed in the electronic apparatus is unable to be used to change the label state.

In addition, in step 404, if it is determined that the number of the free blocks is equal to zero, the label is changed to the second state (1) in step 410, after which the portable data storage device is placed in the abnormal mode in step 406.

In the second preferred embodiment of the present invention, the portable data storage device is placed in various modes depending on the state of the label. Further, in some of the modes, i.e., the abnormal and backup modes, the user is provided with the option of changing the state of the label through the software installed in the electronic apparatus.

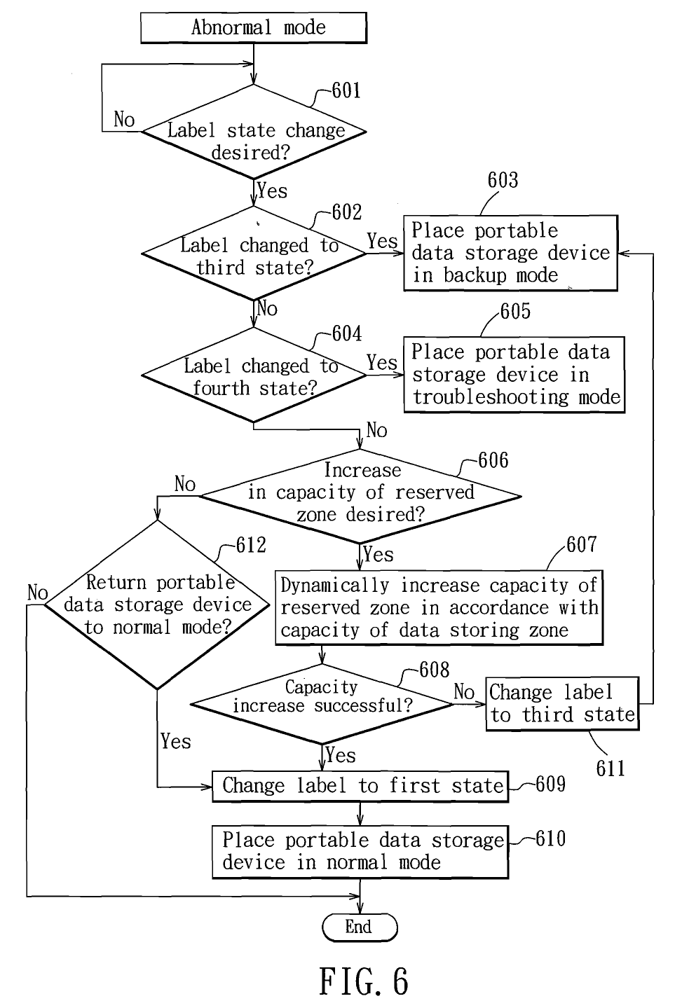

Referring to FIGS. 5 and 6, when the portable data storage device is in the abnormal mode and connected to the electronic apparatus, the software installed in the electronic apparatus automatically or manually runs to configure the electronic apparatus to perform the following steps. In the second preferred embodiment, the software configures the electronic apparatus to enable the user to change the state of the label through the electronic apparatus.

Further, in the second preferred embodiment, the software configures the electronic apparatus to enable the electronic apparatus to dynamically increase the number of the free blocks in the reserved zone according to a capacity of the data storing zone when the label is in the second state (1). This is initiated by user manipulation in the second preferred embodiment.

First, an operating interface is displayed on a screen (not shown) of the electronic apparatus. In step 601, it is determined if the user desires to change the state of the label. If not, step 601 is repeated.

If the user desires to change the label state in step 601, it is determined if the label has been changed to the third state (2) in step 602. If so, in step 603, the portable data storage device is placed in the backup mode.

If the label has not been changed to the third state (2) in step 602, it is determined if the label has been changed to the fourth state (3) in step 604. If so, in step 605, the portable data storage device is placed in the troubleshooting mode.

If the label has not been changed to the fourth state (3) in step 604, this indicates that the user has yet to input the desired change in the state of the label, in which case it is determined in step 606 if the user desires to increase the capacity of the reserved zone of the flash memory (i.e., increase the number of free blocks). If so, this indicates that the portable data storage device entered the abnormal mode since the number of free blocks in the reserved zone is zero.

Therefore, in step 607, the present capacity of the data storing zone is detected, and, in accordance with the capacity of the data storing zone, the capacity of the reserved zone is dynamically increased to thereby increase the number of the free blocks therein.

Subsequently, in step 608, it is determined if the operation to increase the capacity of the reserved zone was successful. If so, the label is automatically changed to the first state (0) in step 609, after which the portable data storage device is placed in the normal mode in step 610.

However, if the operation to increase the capacity of the reserved zone was unsuccessful in step 608, this indicates that the semiconductor memory of the portable data storage device does not have any available space in the data storing zone to be allocated to the reserved zone. Therefore, in step 611, the label is automatically changed to the third state (2) in step 611, after which the portable data storage device is placed in the backup mode in step 603. Alternatively, if it is determined in step 608 that the operation to increase the capacity of the reserved zone was unsuccessful, the process may be directly ended without performing steps 611 and 603 such that the portable data storage device is maintained in the abnormal mode.

In step 606, if the user does not desire to increase the capacity of the reserved zone, this indicates that the portable data storage device entered into the abnormal mode from the normal mode through manual setting by the user, and that the number of the free blocks in the reserved zone is not equal to zero. Therefore, in step 612, it is determined if the user desires to return the portable data storage device to the normal mode. If so, then step 609 is performed for changing the state of the label to the first state (0), after which the portable data storage device is placed in the normal mode in step 610. If the user does not desire to return the portable data storage device to the normal mode in step 612, the process is ended.

Hence, when the portable data storage device is in the abnormal mode, the user is able to change the label state of the portable data storage device through the software installed in the electronic apparatus, and thereby place the portable data storage device in the backup mode where at least reading of the data in the data storage zone is possible, and in the troubleshooting mode where no access to the data storage zone is permitted. In addition, the user may place the portable data storage device back in the normal mode in the case where the portable data storage device entered the abnormal mode through manual setting by the user and not as a result of a depletion of the free blocks in the reserved zone. Finally, the user is able to initiate control to increase the capacity of the reserved zone so that the free blocks therein are increased, and so that the portable data storage device may be placed back in the normal mode.

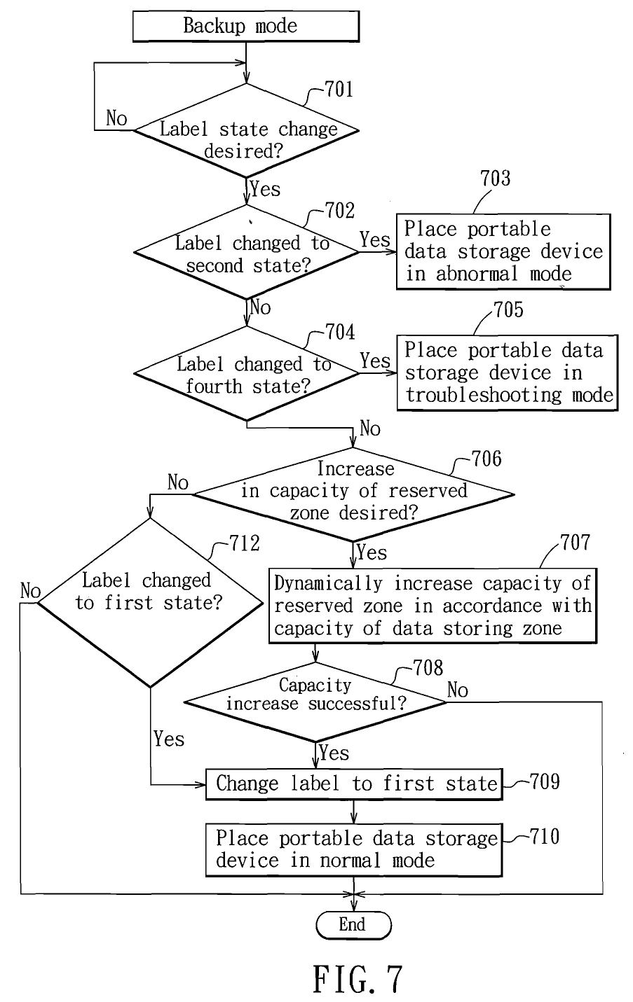

Referring to FIGS. 5 and 7, when the portable data storage device is in the backup mode and connected to the electronic apparatus, the software installed in the electronic apparatus runs to configure the electronic apparatus to perform the following steps. First, it is determined in step 701 if the user desires to change the label state. If so, in step 702, it is determined if the label has been changed to the second state (1).

If the label has been changed to the second state (1) in step 702, the portable data storage device is placed in the abnormal mode in step 703.

If the label has not been changed to the second state (1) in step 702, it is determined if the label has been changed to the fourth state (3) in step 704. If so, in step 705, the portable data storage device is placed in the troubleshooting mode.

If the label has not been changed to the fourth state (3) in step 704, it is determined in step 706 if the user desires to increase the capacity of the reserved zone of the flash memory. If so, steps 707-710 are performed, which are identical to steps 607-610 of FIG. 6, respectively, such that the capacity of the reserved zone is increased and the portable data storage device is reverted to the normal mode.

If the user does not desire to increase the capacity of the reserved zone in step 706, steps 712, 709, and 710 are performed, which are identical respectively to steps 612, 609, and 610 of FIG. 6.

Advantages similar to those achieved with respect to the process of FIG. 6 are realized with the process of FIG. 7.

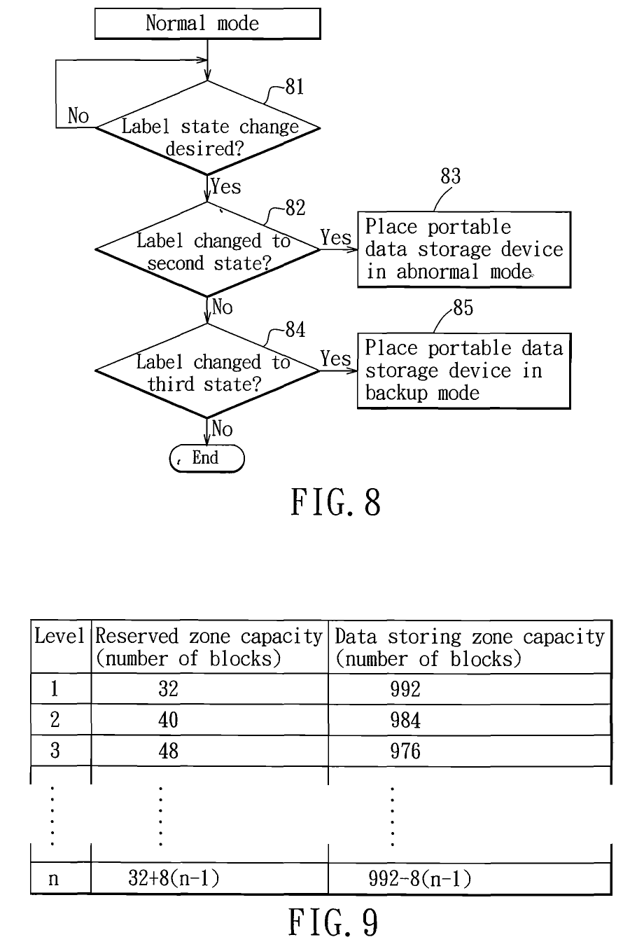

Referring to FIGS. 5 and 8, when the portable data storage device is in the normal mode and connected to the electronic apparatus, the software installed in the electronic apparatus configures the electronic apparatus to perform the following steps. First, it is determined if the user desires to change the label state in step 81. If so, in step 82, it is determined if the label has been changed to the second state (1). If the label has been changed to the second state (1) in step 82, the portable data storage device is placed in the abnormal mode in step 83.

If the label has not been changed to the second state (1) in step 82, it is determined if the label has been changed to the third state (2) in step 84. If so, in step 85, the portable data storage device is placed in the backup mode. If the label has not been changed to the third state (2) in step 84, the process is ended.

Hence, in the normal mode, the user is able to change the label state of the portable data storage device through the electronic apparatus, and thereby place the portable data storage device in the abnormal mode where access to the data in the data storing zone is not permitted, or in the backup mode in which only reading of the data in the data storing zone is permitted. Accordingly, unauthorized access to the portable data storage device is prevented, thereby enhancing the security of the portable data storage device.

Step 607 of FIG. 6 and step 707 of FIG. 7, that is, increasing the capacity of the reserved zone, is performed through a process described below.

In order to perform steps 607 and 707, it is necessary for an allocation look-up table as shown in FIG. 9 to be pre-established in, for example, the ROM of the second memory unit of the portable data storage device. As an example, the allocation look-up table has an n-number of levels, where each level is associated with a reserved zone capacity (in number of blocks) that increases by eight for each level, and a corresponding data storing zone capacity (in number of blocks) that decreases by eight for each level. Using a 128 MB flash memory as an example, when n=1 (first level), the firmware organizes the flash memory to have a reserved zone of 32 blocks and a data storing zone of 992 blocks, where each block is 128 KB. When n=2, the reserved zone is set to have 40 (32+8) blocks and the data storing zone to have 984 (992−8) blocks. This pattern of an increasing reserved zone capacity and a corresponding decreasing data storing zone capacity is continued for n levels. Further, the level being presently used by the portable data storage device is stored as a tag in the other blocks of the reserved zone of the flash memory.

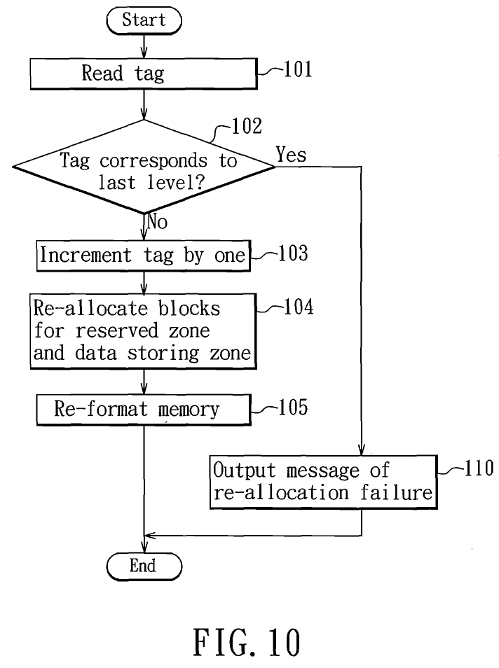

Referring to FIG. 10, the firmware in the portable data storage device configures the electronic apparatus to perform the following process to realize steps 607 and 707 (backup of the data stored in the data storing zone may be performed beforehand).

In step 101, a tag representing the present level is read from the reserved zone. In step 102, it is determined if the tag corresponds to the last level in the allocation look-up table of FIG. 9. If so, a message is output in step 110 to inform the user that a further increase in the level is not possible (i.e., that a re-allocation of the capacities of the reserved zone and the data storing zone is not possible), and the process is ended.

If the tag does not correspond to the last level in the allocation look-up table, the tag is incremented by one in step 103. Next, in step 104, the number of blocks for the reserved zone and the number of blocks for the data storing zone are re-allocated according to the allocation look-up table of FIG. 9. Step 104 may be performed through the firmware. Finally, in step 105, the semiconductor memory is re-formatted to thereby complete the operation of increasing the capacity (number of free blocks) of the reserved zone.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method of dynamic memory management for a portable data storage device having a semiconductor memory that includes a data storing zone for storing data, said method comprising:
a) providing a state-changeable label used for setting an access state of the data storing zone, the label being in one of a first state indicating access to data in the data storing zone is allowed, and a second state indicating access to the data in the data storing zone is restricted;
b) allowing access to the data storing zone when the label is in the first state; and
c) restricting access to the data storing zone when the label is in the second state.

2. The method of claim 1, the data storing zone including a plurality of data blocks, the semiconductor memory further including a reserved zone, the reserved zone having a plurality of free blocks used for memory access operations and replacing bad blocks in the data storing zone, said method further comprising:
d) setting the label to the first state when a number of the free blocks is greater than zero, and setting the label to the second state when the number of the free blocks is equal to zero.

3. The method of claim 2, wherein step d) includes:
d1) determining if the number of the free blocks is equal to zero after accessing the data storing zone; and
d2) setting the label to the second state if the number of the free blocks is equal to zero.

4. The method of claim 1, further comprising:
e) reading the label before accessing the data storing zone, and proceeding to one of steps b) and c) according to the state of the label.

5. The method of claim 1, wherein the portable data storage device further has firmware to configure an electronic apparatus to perform the steps of said method.

6. The method of claim 1, wherein only reading of the data in the data storing zone is permitted when the label is in the second state.

7. The method of claim 1, wherein no access to the data in the data storing zone is permitted when the label is in the second state.

8. The method of claim 7, the portable data storage device being connected to an electronic apparatus, said method further comprising:
d) enabling changing of the state of the label through the electronic apparatus when the label is in the second state.

9. The method of claim 8, wherein, in step d), the state of the label is changeable through the electronic apparatus from the second state to a third state in which only reading of the data in the data storing zone is permitted and further changes in the state of the label are allowed.

10. The method of claim 8, wherein, in step d), the state of the label is changeable through the electronic apparatus from the second state to a fourth state in which access to the data in the data storing zone and further changes in the state of the label are not permitted.

11. The method of claim 2, the portable data storage device being connected to an electronic apparatus, said method further comprising:
e) enabling the electronic apparatus to dynamically increase the number of the free blocks in the reserved zone according to a capacity of the data storing zone when the label is in the second state; and
f) changing the state of the label to the first state after step e).

12. The method of claim 11, wherein, in step e), if it is determined in accordance with the capacity of the data storing zone that it is not possible to further increase the number of the free blocks in the reserved zone, step f) is skipped, and changing of the state of the label through the electronic apparatus to a third state is enabled, the third state permitting only reading of the data in the data storing zone.

13. The method of claim 11, wherein, in step e), if it is determined in accordance with the capacity of the data storing zone that it is not possible to further increase the number of the free blocks in the reserved zone, step f) is skipped, and changing of the state of the label through the electronic apparatus to a fourth state is enabled, the fourth state not permitting access to the data in the data storing zone and further changes to the state of the label.

14. The method of claim 2, wherein the label is stored in the reserved zone of the semiconductor memory.

15. The method of claim 2, wherein the states of the label and corresponding access states of the data storing zone are listed in a mode-label look-up table, and the mode-label look-up table is stored in the reserved zone of the semiconductor memory.

16. The method of claim 8, wherein the electronic apparatus is installed with software to configure the electronic apparatus to perform step d) of said method.

17. The method of claim 8, wherein the portable data storage device further has firmware, and the electronic apparatus is installed with software, the firmware configuring the electronic apparatus to perform steps a), b), and c) of said method, the software configuring the electronic apparatus to perform step d) of said method.
